(19) United States
(12) Patent Application Publication
(10) Pub. No.: US 2026/0306976 A1
(43) Pub. Date: Oct. 8, 2026

(54) FILTER ARRANGEMENTS FOR LIQUIDS AND METHODS OF USE

(71) Applicant: Donaldson Company, Inc., Bloomington, MN (US)

(72) Inventors: Michael S. Courneya, St. Louis Park, MN (US); Kurt B. Joscher, Burnsville, MN (US); Timothy D. Sporre, Brooklyn Park, MN (US)

(21) Appl. No.: 19/575,052

(22) Filed: Mar. 23, 2026

Related U.S. Application Data
(60) Provisional application No. 63/782,351, filed on Apr. 2, 2025.

(51) Int. Cl. B01D 35/30; B01D 27/08

(52) U.S. Cl. CPC B01D 35/306; B01D 27/08; B01D 2201/40

(57) ABSTRACT

A filter cartridge has media construction, a housing, and is connectable with the filter head. A blocking piece ensures proper engagement between the filter cartridge and a filter head. The filter cartridge and house may be a bowl-cartridge assembly. A connection system optimizes vertical travel needed to compress the seals and the perceived effort to install the bowl-cartridge assembly onto a filter head. In one example, the bowl-cartridge assembly has variable connecting sections to provide mechanical advantage.

### CROSS-REFERENCE TO RELATED APPLICATION

This application claims the benefit of U.S. Provisional Application No. 63/782,351, filed Apr. 2, 2025, the disclosure of which is hereby incorporated herein by reference.

### TECHNICAL FIELD

This disclosure relates to liquid filter arrangements useable, for example, to filter any liquids, including fuel, hydraulic fluids, and lubricating fluids. A filter head is described on which a serviceable filter cartridge arrangement is positioned in use. Methods of assembly and use are also provided.

### BACKGROUND

Circulating liquid systems such as fuel, hydraulic fluids, and lubricating fluids, typically require a filter arrangement. The filter arrangement is typically positioned so that the fluids are filtered by passage through filter media positioned within the filter arrangement. Typically the filter arrangement is configured so that the componentry containing the media is a service part, i.e., the media can, periodically, be removed and be replaced.

There are two common types of liquid filter arrangements. The first, typically referred to herein as a “spin-on” type, involves a filter head installed on equipment, and a spin-on filter member or cartridge. The filter member or cartridge is often referred to as “spin-on” because the assembly including the filter media is typically secured to the filter head by threading. In spin-on arrangements, the filter media is typically non-removably secured within a shell or housing as a housing/media combination, and the entire housing/media combination, as a filter member or cartridge, is removed and replaced during servicing.

The second common type of liquid filter arrangement is referred to herein as a bowl/cartridge arrangement. With a bowl/cartridge arrangement, the filter head is again installed on the equipment. The filter media, however, is contained within a filter cartridge in a form removably positioned within a housing or shell. A housing/cartridge combination is again mounted on the filter head for use. However, during servicing, the housing is disconnected from the filter head, the media contained within the housing or shell is replaced, and the same shell or housing, with the replacement media inside, is then remounted on the filter head.

A well-functioning filter arrangement is important in protecting downstream equipment, such as an engine or hydraulic machinery. Improvements in filter arrangements are always desirable.

This disclosure also concerns improvements to filter arrangements described in WO 2021/087125, incorporated herein by reference. The filter arrangements can include filtering many different types of fluids, especially liquid, including, e.g. fuel, lubricants, hydraulic oil, air/oil separation, coolant, urea, water, etc.

### SUMMARY

Here is the corrected summary section without paragraph numbers:

In one aspect, a filter cartridge is provided comprising: a treatment media construction; a connection system secured to the treatment media construction to allow for removable attachment of the filter cartridge to a receiving member; the connection system having a blocking piece to ensure proper engagement between the filter cartridge and the receiving member.

In example embodiments, the treatment media construction has a first end and an opposite second end; a first end construction is adjacent to the first end of the media construction; and the blocking piece extends radially outwardly from the first end construction.

In some examples, the blocking piece extends axially from the first end construction and in a direction away from the treatment media construction.

In some implementations, the first end construction includes an outer radial wall and an axial wall; the axial wall covering the first end of the media construction; a plurality of ribs projecting radially from the outer radial wall of the first end construction; each of the ribs having a terminal end sized to engage a rim of a filter bowl, when the cartridge is inserted into a filter bowl; and the blocking piece being circumferentially spaced adjacent to one of the ribs.

In another aspect, a filter assembly is provided comprising: the filter cartridge as summarized above; and a bowl having an outer radial wall and an interior volume; the filter cartridge being removably mountable within the interior volume; the outer radial wall having a plurality of connecting sections alternating with non-connecting sections; and wherein, when the filter cartridge is positioned within the bowl, the blocking piece is circumferentially adjacent to an end of one of the connecting sections.

In example embodiments, the bowl has an open mouth in communication with the interior volume; the open mouth being defined by an end rim; the mouth having a plurality of recessed sections; the recessed sections being the non-connecting sections of the bowl.

In some implementations, a filter head removably attached to the bowl with the filter cartridge; the filter head having an inner radial surface including a plurality of circumferentially spaced sets of connecting segments constructed and arranged to mate with the connecting sections of the bowl; each connecting segment within each set being axially spaced from an adjacent connecting segment; wherein within each set, each connecting segment is axially spaced close enough to the adjacent connecting segment to block receipt of the blocking piece therebetween.

In another aspect, a method of connecting a filter cartridge to a filter head is provided; the method comprising: putting a filter cartridge into a filter bowl; the filter bowl having connecting sections to result in a bowl-cartridge combination; the filter cartridge having a blocking piece projecting from the filter bowl; inserting the bowl-cartridge combination into a filter head; the filter head having a plurality of circumferentially spaced sets of connecting segments constructed and arranged to mate with the connecting sections of the bowl; and using the blocking piece to ensure that the connecting segments and connecting sections are operatively aligned.

In examples, the step of using the blocking piece includes aligning the connecting segments and connecting sections to allow the bowl-cartridge combination to rotate relative to the filter head.

In another aspect, a connection system for releasably connecting first and second components is provided; the system comprising: a first component having an outer cylindrical wall and a plurality of circumferentially spaced sets of connecting sections; each section having parallel section ridges; each section ridge having a plurality of regions; each region having a lead different from any other region; a second component having an inner cylindrical wall and a plurality of circumferentially spaced sets of connecting segments; each set having parallel connecting segments constructed and arranged to mate with the section ridges.

In example embodiments, each section ridge having first and second opposite ends; and each section ridge has a first region extending from the first end at least partially toward the second end; the first region having a greater lead than any other portion of the section ridge.

In some examples, each section ridge has a third region extending from the second end; each section ridge has a second region extending between the first region and third region; and the lead of the third region is smaller than the lead of the first region or second region.

In some implementations, the lead of the second region is non-constant.

In example embodiments, each section ridge having first and second opposite ends; and a distance L between corresponding points on adjacent parallel section ridges being non-constant along at least a portion of each section ridge; the distance L of each section ridge being greatest at the first end.

In some examples, there are at least two sets of connecting sections; and there are at least two sets of connecting segments.

In some implementations, there are at least three sets of connecting sections; and there are at least three sets of connecting segments.

In example embodiments, there are at least two parallel section ridges; and there are at least two parallel connecting segments.

In some examples, there are at least three parallel section ridges; and there are at least three parallel connecting segments.

In some implementations, the first component is a filter assembly; and the second component is a filter head.

In example embodiments, the filter assembly comprises a filter bowl having a removable filter cartridge; the filter bowl having the outer cylindrical wall and an open mouth; the open mouth being defined by an end rim; the end rim defining recessed sections; and the connecting sections on the outer cylindrical wall alternating with the recessed sections.

In another aspect, a method of releasably connecting first and second components is provided; the method comprising: providing a first component having an outer cylindrical wall and a plurality of circumferentially spaced sets of connecting sections; each section having parallel section ridges; providing a second component having an inner cylindrical wall and a plurality of circumferentially spaced sets of connecting segments; each set having parallel connecting segments constructed and arranged to mate with the section ridges; and aligning the connecting sections and connecting segments; rotating the first component relative to the second component to cause a first amount of vertical motion between the first and second components and a first amount of horizontal motion between the first component and second component; and continuing to rotate the first component relative to the second component to cause a second, smaller amount of vertical motion between the first and second components and a second, greater amount of horizontal motion between the first component and second component.

In example methods, the step of continuing to rotate includes rotating the first component relative to the second component less than 900 to fully engage the connecting sections with the connecting segments.

In some implementations, the first component is a filter assembly; and the second component is a filter head.

According to the present disclosure, a variety of features and techniques are provided that can be implemented in liquid filter arrangements, such as fuel filter arrangement, hydraulic filter arrangement, or lubricant (oil) filter arrangements. Selected ones of the techniques can be applied in, preferably, spin-on filter arrangements or bowl/cartridge arrangements. Techniques described include features incorporated in one or both of the filter head and/or filter member removably mounted on the filter head.

There is no requirement that all of the techniques described herein be incorporated in a given system, for that system to obtain at least some advantage.

### BRIEF DESCRIPTION OF THE DRAWINGS

FIG. 1 is a block diagram of an engine and a filter system, illustrating principles of this disclosure;

FIG. 2 is a perspective view of a filter system, including a filter removably attached to a filter head;

FIG. 3 is a cross-sectional view of the filter system of FIG. 2, the filter system including the filter head and a bowl-cartridge assembly removably attached thereto;

FIG. 4 is a front view of a bowl-cartridge assembly of FIG. 3, removed from the filter head, the bowl-cartridge assembly including a filter bowl holding a removable and replaceable filter cartridge;

FIG. 5 is an exploded perspective view of the bowl and filter cartridge of FIG. 4;

FIG. 6 is a top plan view of the filter cartridge of FIG. 4;

FIG. 7 is an enlarged perspective view of a part of the filter cartridge;

FIG. 8 is a front view of the first end construction used with the filter cartridge of FIG. 4;

FIG. 9 is a perspective view of the filter head of FIG. 3;

FIG. 10 is another perspective view of the filter head of FIG. 3;

FIG. 11 is an enlarged front view of connector segments on the inside wall of the filter head of FIG. 3;

FIG. 12 is a front view of the bowl of FIG. 5;

FIG. 13 is a perspective view of the bowl of FIG. 5

FIG. 14 is another perspective view of the bowl of FIG. 5;

FIG. 15 is an enlarged view of one of the ridges in the connector section on the outside of the bowl of FIG. 5;

FIG. 16 is an end view of the connector sections on the bowl of FIG. 5;

FIG. 17 is an opposite end view of the connector sections of FIG. 16;

FIG. 18 is an enlarged view of 3 of the ridges in the connector section on the outside of the bowl of FIG. 5;

FIG. 19 is a perspective view of an alternative embodiment of an end construction, useable with the cartridges herein;

FIG. 20 is a perspective view of a variation of the embodiment of FIG. 19;

FIG. 21 is a top plan view of the end constructions of FIGS. 19 and 20;

FIG. 22 is a cross-sectional view of an alternative embodiment of a filter system, the filter system including a filter head and a bowl-cartridge assembly removably attached thereto;

FIG. 23 is a front view of the bowl-cartridge assembly of FIG. 22, removed from the filter head, the bowl-cartridge assembly including a filter bowl holding a removable and replaceable filter cartridge;

FIG. 24 is an exploded perspective view of the bowl and filter cartridge of FIG. 23;

FIG. 25 is a top plan view of the filter cartridge of FIG. 23;

FIG. 26 is an enlarged perspective view of a part of the filter cartridge of FIG. 23; and

FIG. 27 is a front view of the first end construction used with the filter cartridge of FIG. 23.

### DETAILED DESCRIPTION

### Overview

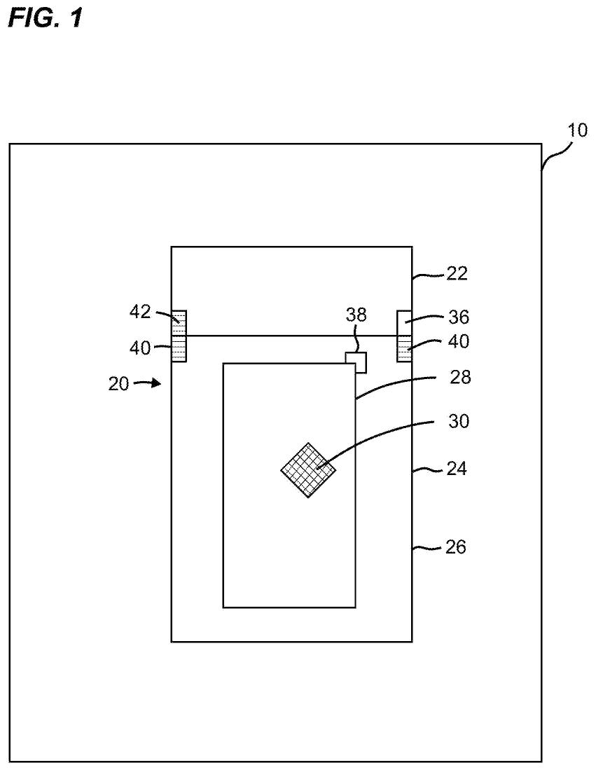

FIG. 1 is a schematic illustration of a system 10, which can be mobile or stationary systems. The system 10 can be an engine on a tractor or any equipment requiring fuel, lubrication, or having powered hydraulics. The system 10 uses a liquid filter assembly 20 for filtering fuel, lubrication fluid, or hydraulic fluid. The liquid filter assembly 20 includes a filter head 22 and a filter arrangement 24. The filter arrangement 24 is removably mountable on the filter head 22. The filter arrangement 24 may be a spin-on filter member (e.g., filter media non-removably secured within a shell or housing) or a bowl-cartridge assembly (a removable and replaceable filter cartridge held within a housing or bowl). In FIG. 1, the filter arrangement 24 includes a housing or bowl 26 holding filter media, which can be in the form of a filter cartridge 28.

In general, the filter cartridge 28 includes a treatment media construction 30, which may include various types of a filter media, including, e.g. cellulose, synthetic, fibrous, or combinations thereof. The media construction 30 may be pleated media, depth media, Z-media, or combinations. The media construction 30 can be in a tubular (e.g. cylindrical) configuration, or panel, or v-packs, for example.

The filter arrangement 24 optionally includes a connection system 36 secured to the treatment media construction 30 to allow for removable attachment of the filter cartridge 28 to a receiving member. The receiving member may include, for example, filter head 22. In one example arrangement, the connection system 36 has a blocking piece 38 to ensure proper engagement between the filter cartridge 28 and the filter head 22. For example, in systems that include threads, or not threads—but ridges or projections, it may be possible to cross-up the threads or ridges/projections and improperly align the connections between the filter cartridge 28 and filter head 22. The blocking piece 38 is useable to make sure the proper engagement is made, and the threads or ridges/projections are properly aligned.

Independent of above, the connections system 36 of the liquid filter assembly 20 may optionally include a system for releasably connecting first and second components. The system can include a first component, such as filter arrangement 24, and second component being the filter head 22. The connection system 36 is designed to have more vertical motion between the filter arrangement 24 and the filter head 22 upon initial connection, and then have more horizontal motion than vertical motion during the latter stages of connection. One of the filter arrangement 24 or the filter head 22 can have a plurality of circumferentially spaced sets of connecting sections, and each section having parallel section ridges 40. The connecting sections have a distance L between corresponding points on adjacent parallel section ridges 40 which is non-constant along at least a portion of each section ridge. The other of the filter arrangement 24 or filter head 22 can have a plurality of circumferentially spaced sets of connecting segments, each having parallel segment projections 42 constructed and arranged to mate with the section ridges 40.

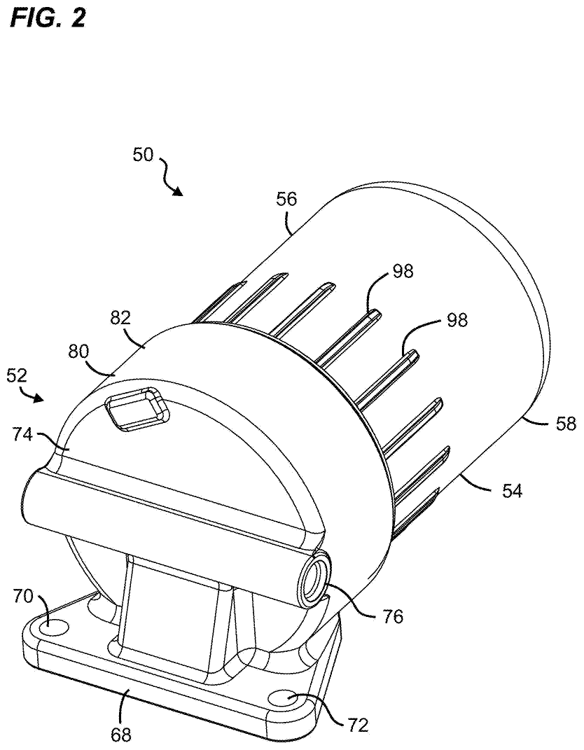

### Example Filter Assembly, FIGS. 2-5

In FIG. 2, reference numeral 50 generally indicates a liquid filter assembly according to the present disclosure. The liquid filter assembly 50 includes filter head 52 and filter arrangement 54. The filter head 52 is typically installed on equipment, in a liquid line, for example a fuel line, hydraulic line, or lubricating fluid (oil) line. During servicing the filter head 52 would typically remain in place in the equipment.

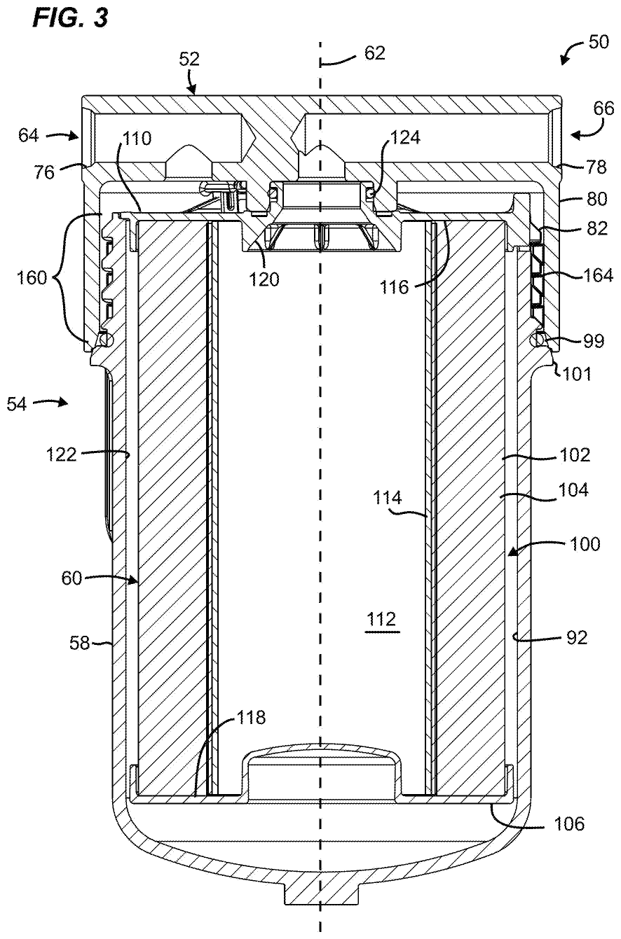

The filter arrangement 54, on the other hand, is removably mounted on the filter head 52. Servicing is provided by replacement of the media contained within the filter arrangement 54. The filter arrangement 54 depicted herein is a bowl-cartridge filter assembly 56, including an outer housing or bowl 58 and a removable and replaceable filter cartridge 60 (FIG. 3). During servicing, the filter arrangement 54 is removed from the filter head 52; the filter cartridge 60 is removed from the bowl 58 and discarded. An entirely new filter cartridge 60 is provided and inserted into the filter bowl 58 and then, the bowl-cartridge filter assembly 56 is again attached to the filter head 52.

In the cross section of FIG. 3, a central longitudinal axis 62 is depicted, around which the filter assembly 50 is positioned. The terms “axial”, “axially” and variants thereof, as used herein, is generally meant to refer to a feature extending in the general direction of the axis 62. The terms “radial”, “radially”, and variants thereof, are meant to refer to a direction toward or away from the axis 62.

Still in reference to FIG. 3, the filter head 52 includes a liquid flow inlet 64 and a liquid flow outlet 66. During operation, liquid to be filtered is directed into the filter head 52 through the inlet 64. Liquid is then directed through the filter arrangement 54 for filtration. The filtered liquid is then returned to the filter head 52 to exit through the outlet 66. In some systems, the flow can be reversed, such that the inlet 64 and outlet 66 are reversed (liquid flows into 66, through the filter arrangement 54, and then out through 64).

In a typical system, the filter head 52 comprises a cast metal part, for example, cast aluminum, with various features added thereto. The filter head 52 may also be plastic or have plastic injection material.

While many embodiments are possible, in the one shown, the filter head 52 includes a flange 68 (FIG. 2), which can have bolt holes 70, 72 for securing the filter head 52 to the equipment.

Secured to the flange 68 is an end wall 74. The end wall 74 will typically include an inlet opening 76 in communication with the inlet 64, to allow for the flow of liquid from the filter head 52 into the filter arrangement 54. End wall 74 will also have an outlet opening 78 to allow for the flow of filtered liquid from the filter arrangement 54 into the filter head 52 to allow it to exit through the outlet 66. The end wall 74 has an inner surface 75 (FIG. 9).

Extending axially from the end wall 74 is a surrounding wall 80 with an exterior surface 82 and an opposite interior or inner radial surface 84 (FIG. 9).

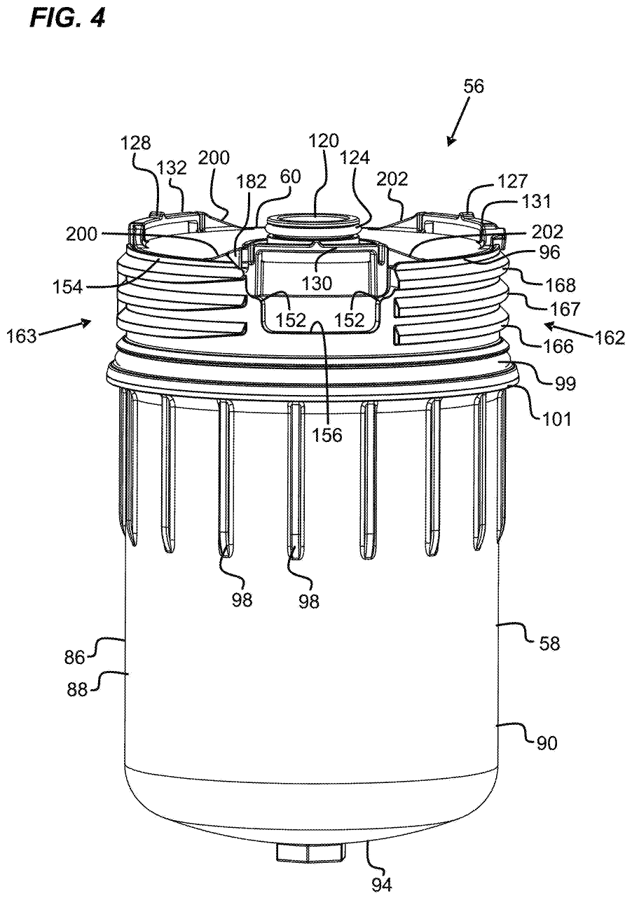

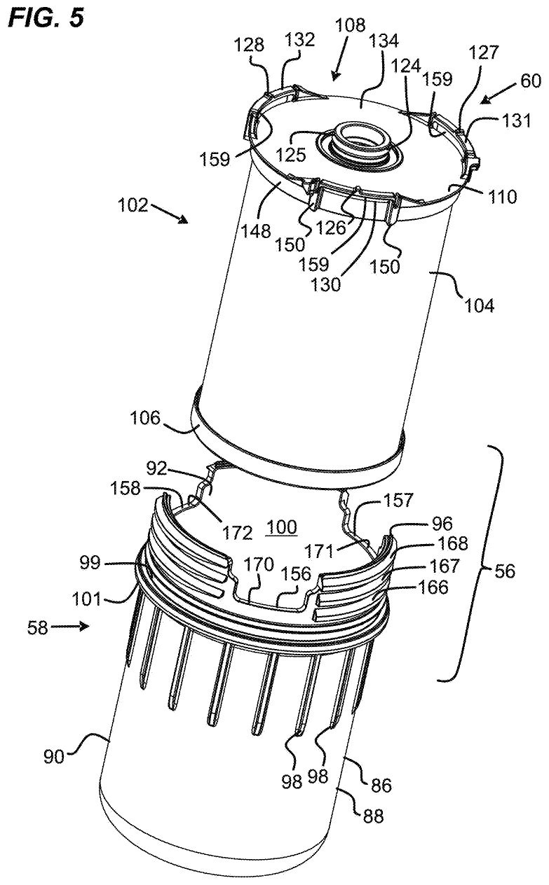

The bowl-cartridge filter assembly 56 is shown in perspective view in FIG. 4 and in exploded view in FIG. 5. The filter bowl 58 includes an external can or shell 86 that has a surrounding wall 88. The surrounding wall 88 has an exterior surface 90 and an opposite interior surface 92. There is a closed bottom 94 and an opposite mouth 96 that interfaces with the filter head 52.

The shell 86 can include a plurality of anti-slip ribs 98 circumferentially spaced about the shell 86 adjacent to the mouth 96. The ribs 98 can be helpful for the user to be able to apply a grip on the assembly 56, when attaching or removing the assembly 56 and the filter head 52.

The bowl 58 holds a seal member 99 to form a seal between the filter head 52 and the bowl 58 to prevent fluid leaking from the filter assembly 50 into the surrounding environment. Alternatively, in a suction application, the seal member 99 blocks air and contaminants from entering the closed system. In the example shown, the seal member 99 is against the exterior surface 90 of the wall 88 of the bowl 58. The seal member 99 is positioned just above and against a stop member 101 radially projecting from a remaining part of the wall 88 of the bowl 58. As explained below, there is a connection system 160, and the seal member 99 is between the stop member 101 and the connection system 160. The connection system 160 is immediately adjacent to the mouth 96 of the bowl 58, such that the connection system 160 is located axially between the mouth 96 and the seal member 99.

Typically, the outer shell 86 may be metal or plastic. The shell 86 defines an interior volume 100. Within the interior volume 100 is positioned the filter cartridge 60. The filter cartridge 60 comprises a treatment media construction 102 including filter media 104 positioned in extension between a second (lower) end cap 106 and a first (upper) end construction 108. The end construction 108 is adjacent to a first end of the media construction 102 and can be part of a first end cap 110 secured to the media construction 102. The media 104 can comprise a variety of materials as selected for the particular operation and conditions to be encountered. Typically, the filter media 104 would be provided in a pleated form, although alternatives are possible. A variety of types or shapes of media or media pleats can be used. Adhesive beads, for example, can help maintain media integrity and pleat spacing. In some alternative arrangements, the media 104 can be lined with a plastic or wire mesh screen, if desired.

Referring to FIG. 3, filter media construction 102 can be tubular in shape and configured around, and defines, an open filter interior volume 112. Positioned within the open filter interior volume 112 is an internal media support 114, in this example, comprising a porous liner extending along the media 104 between the end caps 106, 110 and secured to the end caps 106, 110.

Although alternatives are possible, in the example shown, the second end cap 106 is a closed end cap, meaning it has a closed center prohibiting passage therethrough of unfiltered liquid. The tubular filter media construction 102 has a first end 116, which is secured to the first end cap 110, and an opposite second end 118, which is secured to the second end cap 106. The media 104 is secured to the second end cap 106 by various methods, including adhering or potting, or by molding in place on the media 104. A variety of materials can be used for the end caps 106, 110, which can include metal or plastic.

The first end cap 110 is typically an open end cap defining a central flow aperture 120 therethrough. The aperture 120 is positioned in direct flow communication with the interior volume 112. Herein, the term “direct flow communication” is meant to refer to a passageway that allows a flow communication with the interior volume 112 in a manner that does not require passage through the media 104. That is, liquid within the interior volume 112 can flow through the aperture 120 directly, without passing through the media 104 at the same time. Of course, the liquid does not reach the interior volume 112 unless it has first passed through the media 104 in the first instance, for an “out-to-in” flow arrangement as described.

As indicated, the filter cartridge 60 depicted is configured for out-to-in flow, during filtering. By this, it is meant that unfiltered liquid is directed from the filter head 52 and into an annulus 122 between an outside of the media 104 and an interior surface 92 of the wall 88; and then through the media 104, through the support 114, and into the interior volume 112. The filtered liquid is then directed upwardly through central flow aperture 120 in the first end cap 110, back into the filter head 52 through the outlet opening 78 and then out through the outlet exit 66.

It is noted that many of the principles described herein can be utilized in association with a “in-to-out” flow arrangement, in which the flow direction for liquid being filtered is in the reverse direction, i.e., through the aperture 120, into the interior 112, through the media 104, into the annulus 122, and then back into the filter head 52.

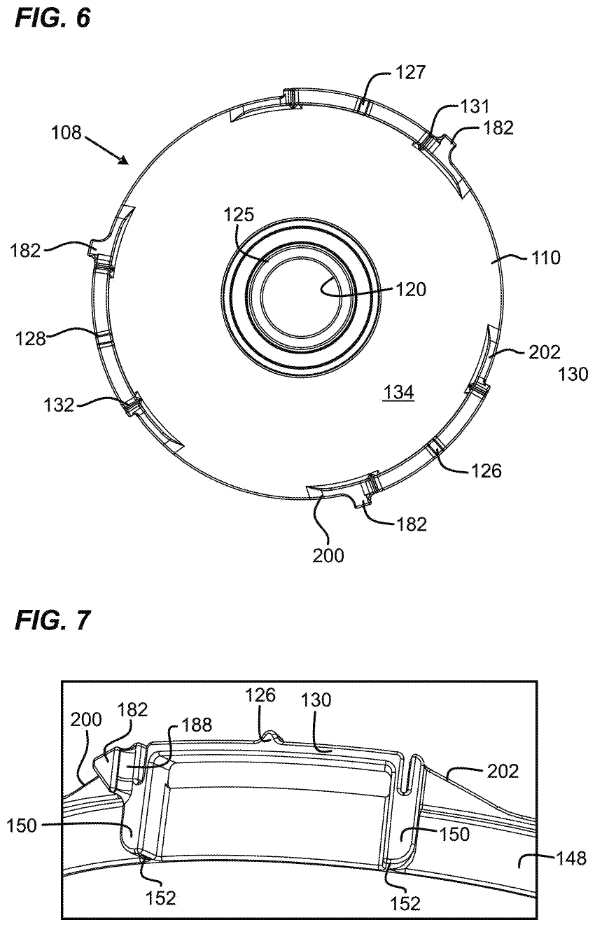

In general, a seal arrangement is needed between the filter cartridge 60 and the filter head 52 in order to prevent liquid flow from bypassing the media 104 as it is directed through the filter cartridge 60. Such a seal arrangement is provided by a seal member 124 on the cartridge 60 to form a seal between and against the cartridge 60 and the filter head 52. In the example shown, the first end construction 108 includes an open spigot 125 (FIGS. 5 and 6) projecting axially therefrom. The open spigot 125 provides communication with the open interior volume 112. The seal member 124 is a radially directed seal member on an outer wall of the spigot 125 to provide an outwardly directed radial seal with the filter head 52, when the filter cartridge 60 is attached to the filter head 52.

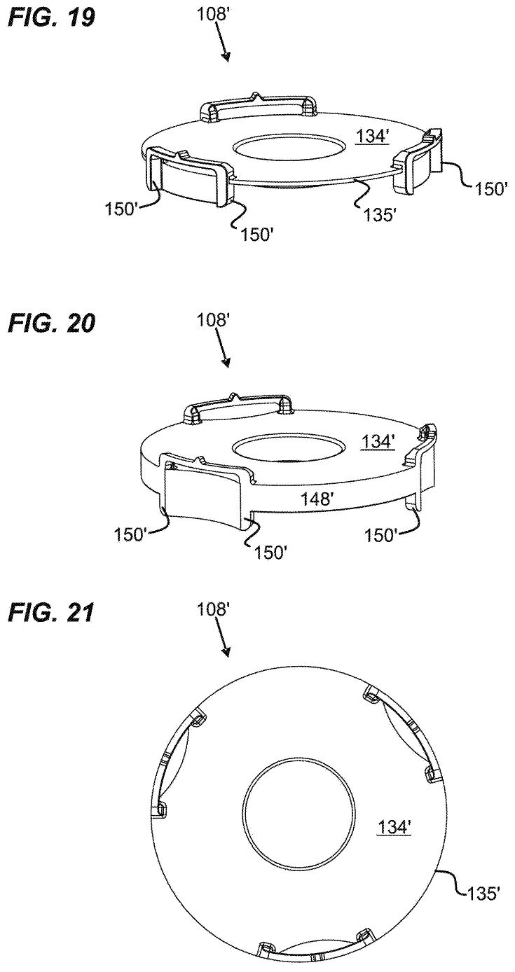

The first end construction 108 includes an outer radial wall 148 and the axial wall 134. The axial wall 134 covers the first end 116 of the media 104. A plurality of ribs 150 project radially from the outer radial wall 148 of the first end construction 108. Each of the ribs 150 has a terminal end 152 positioned and sized to engage the filter bowl 58, when the cartridge 60 is inserted into the bowl 58. Alternatively, as shown in FIGS. 19-21, the ribs 150′ are contained within the outer radial wall 148′ (FIG. 20); or do not project beyond the rim 135 of the axial wall 134′ (FIG. 19) of the first end construction 108′. A top, plan view of each of the embodiments of FIGS. 19 and 20 is shown in FIG. 21, and it can be appreciated that the ribs 150′ are contained within or do not project radially from the radial wall 148′ or rim 135.

In reference again to FIGS. 4 and 5, the mouth 96 of the bowl 58 is defined by an end rim 154. As can be seen in FIGS. 4 and 5, the mouth 96 has a plurality of recessed sections 156, 157, 158. When the filter cartridge 60 is operatively positioned within the bowl 58, the terminal ends 152 of the ribs 150 engage against the rim 154, within the recessed sections 156-158 of the bowl 58.

### Example Connection System

In accordance with principles of this disclosure, the filter cartridge 60 includes a system to allow for installation of the filter arrangement 54 to the filter head 52 with a perceived easier effort, while resulting in a reliable seal compression. The system will also include simply inserting and rotating the filter arrangement 54 less than a full turn. In this embodiment, the system includes a connection system 160 (FIG. 3). The connection system 160 changes leads to provide mechanical advantage when needed most to counter increasing forces of seal members 124, 99. The connection system 160 eliminates cross-threading, and lends itself to having the connectors be specific to specific customers.

In the example embodiment illustrated in FIGS. 4 and 5, the connection system 160 includes a plurality of circumferentially spaced connecting sections, illustrated herein as 162, 163, and 164 (FIG. 3) located on the filter assembly 56, and in the example shown, the bowl 58. Each connecting section 162, 163, 164 includes a plurality of parallel section ridges 166, 167, 168.

The section ridges 166-168 can be in the form of helical profiles extending circumferentially along and projecting from the outer radial wall 88 of the bowl 58. By “helical profile”, it is meant the geometrical outline along an outermost border which, if continued, would have a general spiral shape. Although in some embodiments, screw threads can be used, a helical profile is not a screw thread. In a helical profile, a plane perpendicular to the central longitudinal axis will pass through more than one profile, whereas in a screw thread, a plane perpendicular to the central longitudinal axis will pass through only one thread profile.

Preferably, each connecting section 162, 163, 164 is identical to the other connecting sections 162, 163, 164. This means that when mounting the bowl-cartridge assembly 56 onto the filter head 52, the user does not have to be concerned about matching the correct connecting section 162, 163, 164 with the particular receiving connecting segments on the filter head 52. In alternative embodiments, the connecting sections 162-164 can be different from each other.

Preferably, the outer radial wall 88 has a plurality of alternating circumferentially spaced connecting sections 162, 163, 164 and alternating non-connecting sections 170, 171, 172. In the example shown, the recessed sections 156, 157, 158 form the non-connecting sections 170, 171, 172.

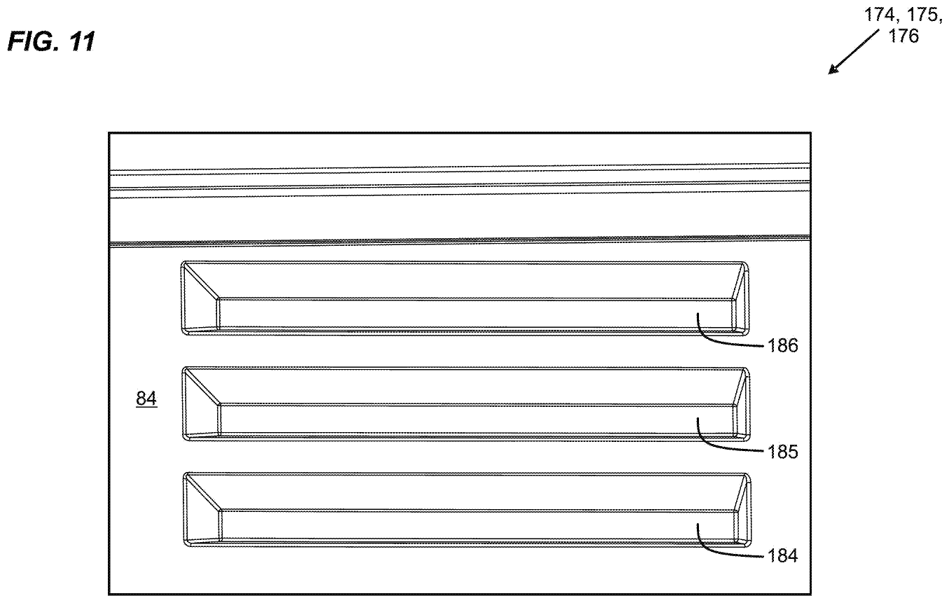

In reference now to FIGS. 9-11, the filter head 52 is shown in further detail. The inner radial surface 84 of the filter head 52 includes a plurality of circumferentially spaced sets 174, 175, 176 of connecting segments 184, 185, 186 constructed and arranged to mate with the connecting sections 162, 163, 164 of the bowl-cartridge assembly 56. The connecting sets 174, 175, 176 are circumferentially spaced along the inner radial surface 84 and are separated by smooth, ungrooved, portions 178, 179, 180 of the inner radial surface 84. FIG. 11 shows an enlarged view of the segments 184-186. While in some embodiments, the segments 184-186 can vary in size and shape, in the example shown, the segments 184-186 are the same shape, with equal spacing therebetween. They are generally straight and uniform across the entire length of each.

In accordance with principles of this disclosure, the connection system 160 includes a blocking piece 182 to ensure proper engagement between the filter cartridge 60 and filter head 52. Attention is directed to FIGS. 4 and 7. In this example embodiment, the blocking piece 182 extends axially from the first end construction 108 and in a direction away from the treatment media construction 102. The blocking piece 182 is circumferentially spaced adjacent to one of the ribs 150 on the outer radial wall 148 of the first end construction 108. When the filter cartridge 60 is positioned within the bowl 58, the blocking piece 182 is just above the rim 154 of the bowl 58 and immediately adjacent to the recessed sections 156-158. The blocking piece 182 is also circumferentially adjacent to an end of one of the connecting sections 162-164.

The blocking piece 182 can be made in many different configurations. In the example shown in FIG. 7, the blocking piece 182 is triangle-shaped, and oriented so that one of the sides 188 faces the segments 184-186 of the sets 174-176 of segments 184-186. The length of the side 188 is larger than the spacing between each segment 184, 185, 186. In alternatives, the blocking piece 182 can be the connecting sections 162-164 themselves, if designed to have different leads, pitches, or thicknesses, etc.

In reference again FIG. 11, each connecting segment 184, 185, 186 within each set 174, 175, 176 is axially spaced from an adjacent connecting segment 184, 185, 186. Within each set 174, 175, 176, each connecting segment 184, 185, 186 is axially spaced close enough to the adjacent connecting segment 184, 185, 186 to block receipt of the blocking piece 182 therebetween. This ensures that the profiles 166-168 are properly aligned with the segments 184-186.

The above can be used in a method of connecting filter cartridge 60 to filter head 52. The method includes putting the filter cartridge 60 into the filter bowl 58, the filter bowl having connecting sections 162-164 to result in bowl-cartridge assembly or combination 56. The filter cartridge 60 has blocking piece 182 projecting from the filter bowl 58. Next, there is the step of inserting the bowl-cartridge combination 56 into the filter head 52. The filter head 52 has the circumferentially spaced sets 174-176 of connecting segments 184-186 constructed and arranged to mate with the connecting sections 162-164 of the bowl 58. Next, the method includes using the blocking piece 182 to ensure that the connecting segments 184-186 and connecting sections 162-164 are operatively aligned. The step of using the blocking piece 182 includes aligning the connecting segments 184-186 and connecting sections 162-164 to allow the bowl-cartridge combination 56 to rotate relative to the filter head 52.

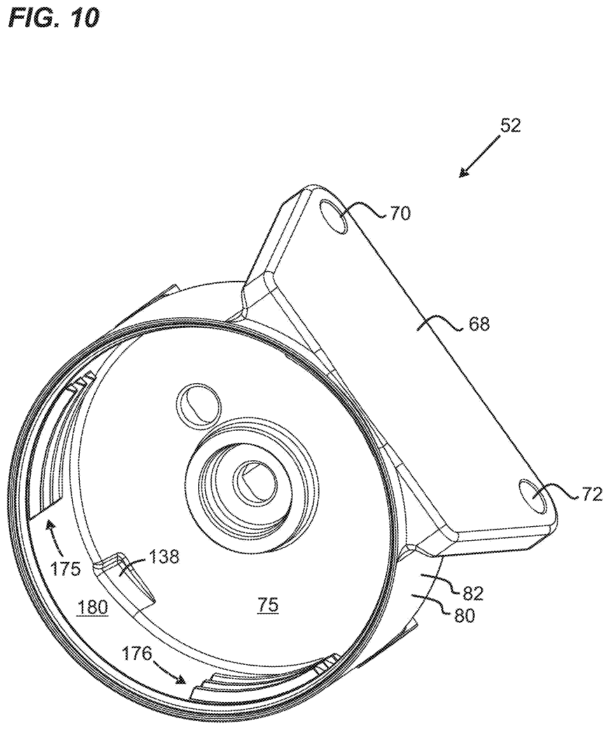

Some methods further include rotating the bowl-cartridge combination 56 less than 90° to engage the connecting segments 184-186 and connecting sections 162-164 until the detent 126-128 snaps over projection 136-138 (FIGS. 9 and 10) in the filter head 52.

### Connection System Advantages

A connection system is designed to optimize vertical travel needed to compress the seals and the perceived effort to install the bowl-cartridge assembly 56 onto the filter head 52.

In the example embodiment shown herein, the bowl-cartridge assembly 56 is shown and described as having selected variable connecting sections, but it should be understood that it could also be implemented on the connecting segments of the filter head 52.

Each section ridge 166-168 has a plurality of regions, with each region having a lead different from any other region. The regions can be either “constant lead” regions or “transition lead” regions. As used herein, “lead” means an axial distance of travel per 360° of rotation. This variable lead configuration facilitates controlled engagement between the connecting sections and the connecting segments during rotation of the filter assembly relative to the filter head. By “constant lead,” it is meant the region has a steady, unchanging lead (constant) lead. By “transition lead”, it is meant the region has an unconstant, changing lead throughout the region.

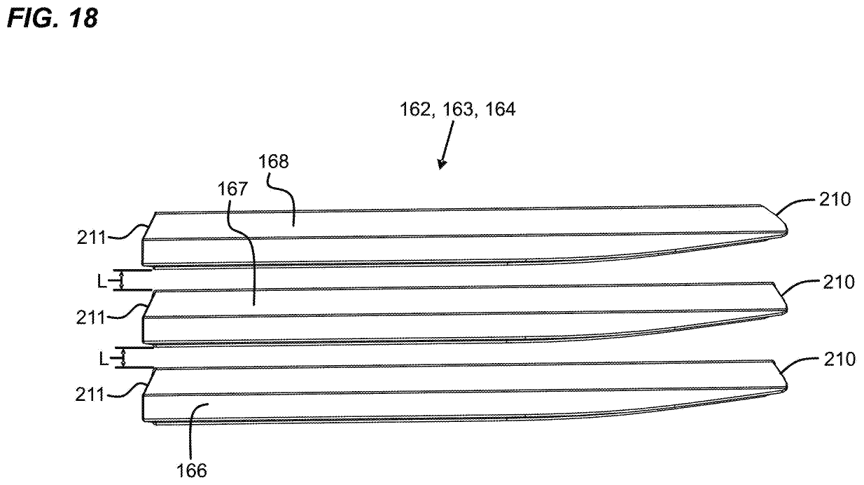

Reference is made to FIG. 18. Each connecting section ridge 166, 167, 168 is parallel to each other. Each connecting section ridge 166, 167, 168 has a distance L between corresponding points on adjacent parallel section ridges being non-constant along at least portion of each section ridge 166, 167, 168. For example, each connecting section ridge 166, 167, 168 has an opposite first end 210 and second end 211. The distance L is different at the first end 210 (FIG. 17) than at the second end 211 (FIG. 16). In this example, the distance L at the first end 210 is greater than the distance L at the second end 211. In this example, the distance L is greatest at the first end 210 than any other section of the ridge 166-168.

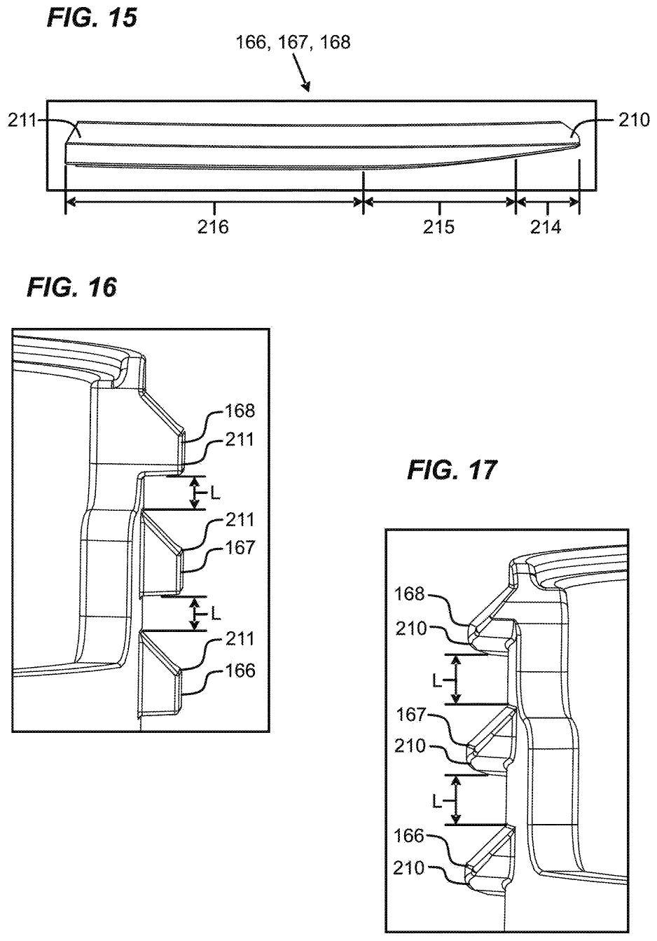

FIG. 15 shows an enlarged view of one of the ridges 166-168. Each ridge 166-168 has a first region 214 extending from the first end 210 at least partially toward the second end 211. The first region 214 has a greater lead than any other portion of the section ridge.

In this example, each ridge 166-168 has a second region 215 extending from the first region 214 to a third region 216. The third region 216 extends from the second region 215 to the second end 211. The distance L at the third region 216 is constant along the third region 216. The second region 215 has a distance L which is less than at the first region 214, and more than the third region 216.

The first region 214 extends at least 2% of the overall length of the ridges 166-168 and less than 30% of the overall length. In many examples, the first region 214 extends between 5% and 20% of the overall length. In this example, the first region 214 is the initial part of the connection sections 162-164—the part that is first engaged when connecting to the sets 174-176 of connecting segments 184-186. The second region 215 extends at least 10% of the overall length of the ridges 166-168, and in many examples, extends between 15% and 40% of the overall length. The third region 216 extends at least 40% of the overall length of the ridges 166-168, and in many examples, extends between 50% and 70% of the overall length.

FIG. 11 shows an enlarged view of one of the sets 174, 175, 176 of connecting segments 184, 185, 186. The sets 174-176 of connecting segments 184-186 are located on the inner cylindrical wall 84 of the filter head 52 and are circumferentially spaced from each other, with smooth portions 178, 179, 180 between each set 174-176. Each segment 184-186 is parallel to each other, and they are constructed and arranged to receivably mate (connect) with the ridges 166-168.

Each ridge 166-168 has a lead. The leads are different in each region 214, 215, and 216. In general, the lead at region 214 and region 216 are constant, with the lead at region 215 being transitional (non-constant). Although the lead at region 215 is transitional and non-constant, there is an average lead for region 215 across that region.

This arrangement has advantages. Because of the variable leads of the ridges 166-168, especially since the lead is greatest at the first region 214—the part that is first engaged when connecting to the sets 174-176 of the connecting segments 184-186, there is a large relative vertical motion between the filter assembly 56 and the filter 52 when the connection is first being made, which translates into low installation force. This is then followed by a mid force being needed at second region 215, and then a large force needed for the third region 216, when the third region 216 is engaging the connecting segments 184-186, and compressing the seal member 124 between and against the cartridge 60 and the filter head 52. This is explained more below.

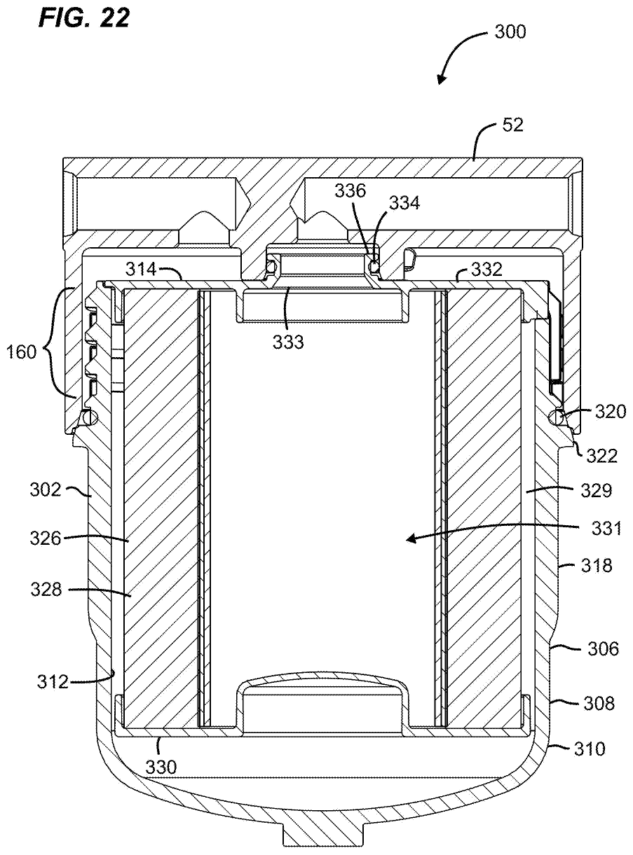

During installation, the person installing the assembly 56 to the filter head 52 must overcome forces associated with the seal compression of seal members 124 and 99. Through limited motion, the seal members 99 and 320 (embodiment of FIGS. 22-27) go from zero compression (no force) to target compression (max force). The leads on the ridges 166-168 provide mechanical advantage. Mechanical advantage increases as required force increases.

An example is shown below:

| | Third region | Second region | First region |
|---|---|---|---|
| | 216 | 215 (average) | 214 |
| Compression force | Maximum | Mid force | Low to no |
| of Seal Member | force | | force |
| 99, 320 | | | |
| Lead (axial | 4 mm | Average of 21 | 38 mm |
| distance per 360° | | mm | |
| rotation) | | | |
| Mechanical | High | Medium | Low |
| Advantage | | | |

The compression force of the seal members 99, 320 is not linear, and it is the driving installation force. Varying the lead provides mechanical advantage when needed most to counter increasing forces of the seal members 99, 320. The arrangement described herein optimizes the vertical travel needed over the course of the leads of the ridges 166-168 and the perceived effort to install the assembly 56 onto the filter head 52.

Many variations are possible. In the example embodiment shown, there are at least three sets 162-164 of connecting section ridges 166-168, and at least three sets 174-176 of connecting segments 184-186. In other embodiments, there may be fewer, such as at least two sets of each. Shown in the example embodiments, there are at least three parallel section ridges 166-168 and three parallel segments 184-186, but in other embodiments, there may be at least two parallel section ridges 166 and two parallel segments 184.

The above can be used in a method of releasably connecting first and second components, such as filter assembly 56 and filter head 52. The method includes providing a first component, such as the bowl-cartridge filter assembly 56, having outer cylindrical wall 88 and plurality of circumferentially spaced sets 162, 163, 164 of connecting sections having parallel section ridges 166, 167, 168.

Next, the method includes providing a second component, such as filter head 52, having inner cylindrical wall 84 and plurality of circumferentially spaced sets 174, 175, 176 of connecting segments 184, 185, 186. Each set 174-176 has parallel connecting segments 184-186 constructed and arranged to mate with the section ridges 166-168.

Next, the method includes aligning the connecting ridges 166-168 and connecting segments 184-186.

The method next includes rotating the filter assembly 56 relative to the filter head 52 to cause a first amount of vertical motion between them and a first amount of horizontal motion between them.

The method includes continuing to rotate the filter assembly 56 relative to the filter head 52 to cause a second, smaller amount of vertical motion between the filter assembly 56 and filter head 52 and a second, greater amount of horizontal motion between the components, as compared to the first amount of vertical motion and first amount of horizontal motion.

In many preferred methods, the step of continuing to rotate includes rotating the filter assembly relative to the filter head less than 900 to fully engage the connecting sections 162-164 of ridges 166-168 with the sets 174-176 of connecting segments 184-186.

While rotating, the method includes compressing seal member 124 on the filter cartridge 60 to form a seal between and against the head 52 and the filter cartridge 60. The method also includes compressing seal member 99 on the bowl 58 between and against the inner surface 84 of the wall 80 of the filter head 52 and the exterior surface 90 of the wall 88 of the bowl 58.

### The Filter Assembly of FIGS. 22-27

Referring now to FIGS. 22-27, an alternative embodiment of a liquid filter assembly is illustrated and generally designated by reference numeral 300. The filter assembly 300 shares common features with the filter assembly 50 described above, particularly with respect to the connection system 160, but includes a different first end construction 314, as described below.

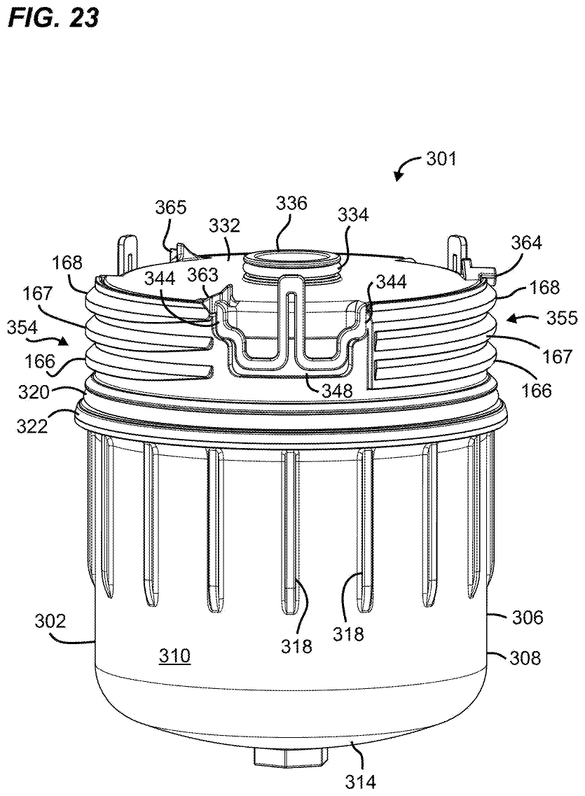

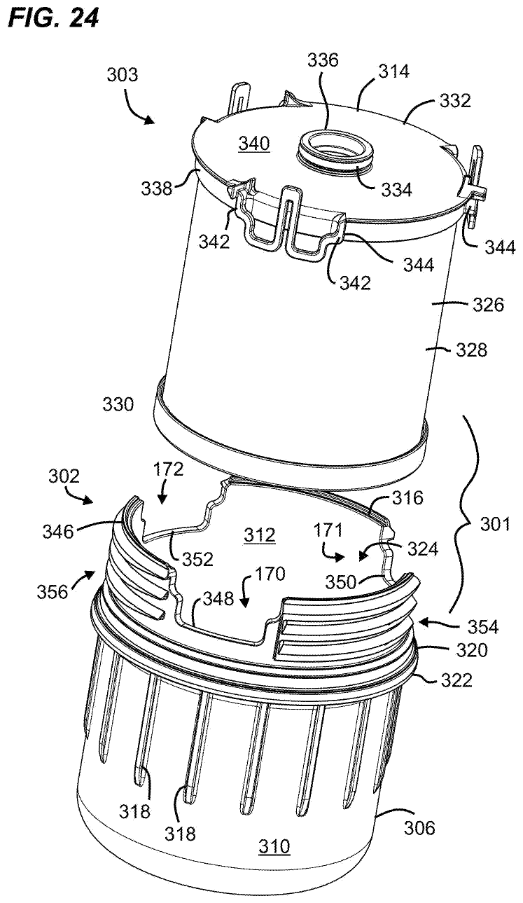

The filter assembly 300 includes a bowl-cartridge filter assembly 301, including an outer housing or bowl 302 and a removable and replaceable filter cartridge 303 (FIGS. 23-24). The filter assembly 300 is constructed and arranged for removable mounting on the filter head 52 in the same manner as assembly 50, using the same connection system 160 described above. During servicing, the filter assembly 300 is removed from the filter head 52; the filter cartridge 303 is removed from the bowl 302 and discarded. An entirely new filter cartridge 303 is provided and inserted into the filter bowl 302 and then, the bowl-cartridge filter assembly 301 is again attached to the filter head 52.

The bowl-cartridge filter assembly 301 is shown in front view in FIG. 23 and in exploded perspective view in FIG. 24. The filter bowl 302 includes an external can or shell 306 that has a surrounding wall 308. The surrounding wall 308 has an exterior surface 310 and an opposite interior surface 312. There is a closed bottom 314 and an opposite mouth 316 that interfaces with the filter head 52.

The shell 306 can include a plurality of anti-slip ribs 318 circumferentially spaced about the shell 306 adjacent to the mouth 316. The ribs 318 can be helpful for the user to be able to apply a grip on the assembly 301, when attaching or removing the assembly 301 from the filter head 52.

The bowl 302 holds a seal member 320 to form a seal between the filter head 52 and the bowl 302 to prevent fluid leaking from the filter assembly 300 into the surrounding environment. In the example shown, the seal member 320 is against the exterior surface 310 of the wall 308 of the bowl 302. The seal member 320 is positioned just above and against a stop member 322 radially projecting from a remaining part of the wall 308 of the bowl 302. The connection system 160 is immediately adjacent to the mouth 316 of the bowl 302, such that the connection system 160 is located axially between the mouth 316 and the seal member 320.

The shell 306 defines an interior volume 324. Within the interior volume 324 is positioned the filter cartridge 303. The filter cartridge 303 comprises a treatment media construction 326 including filter media 328 positioned in extension between a second (lower) end cap 330 and a first (upper) end construction 314. The end construction 314 is adjacent to a first end of the media construction 326 and can be part of a first end cap 332 secured to the media construction 326. The media 328 can comprise a variety of materials as selected for the particular operation and conditions to be encountered. Typically, the filter media 328 would be provided in a pleated form, although alternatives are possible.

The second end cap 330 is a closed end cap, meaning it has a closed center prohibiting passage therethrough of unfiltered liquid. The tubular filter media construction 326 has a first end, which is secured to the first end cap 332, and an opposite second end, which is secured to the second end cap 330.

The first end cap 332 is typically an open end cap defining a central flow aperture 333 therethrough. The aperture is positioned in direct flow communication with an interior volume 331 defined by the media construction 326. The filter cartridge 303 is configured for out-to-in flow during filtering. Unfiltered liquid is directed into an annulus 329 between an outside of the media 328 and the interior surface 312 of the wall 308; and then through the media 328 and into the interior volume. The filtered liquid is then directed upwardly through the central flow aperture in the first end cap 332, back into the filter head 52 and then out through the outlet exit.

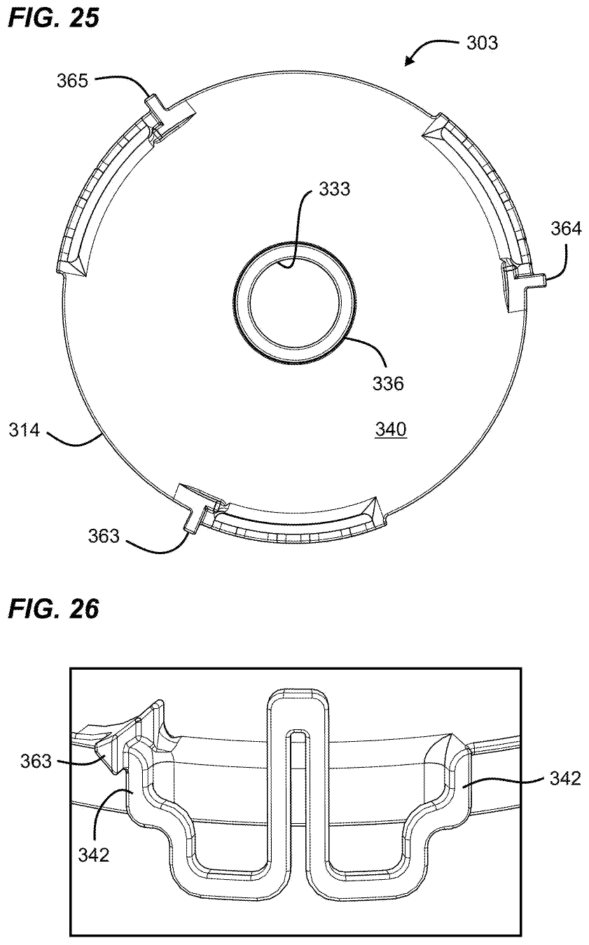

A seal arrangement is provided by a seal member 334 on the cartridge 303 to form a seal between and against the cartridge 303 and the filter head 52. In the example shown, the first end construction 314 includes an open spigot 336 (FIGS. 25-26) projecting axially therefrom. The open spigot 336 provides communication with the open interior volume 331. The seal member 334 is a radially directed seal member on an outer wall of the spigot 336 to provide an outwardly directed radial seal with the filter head 52, when the filter cartridge 303 is attached to the filter head 52. The seal member 334 could also be an inwardly directed radial seal; an axial seal, or a grommet.

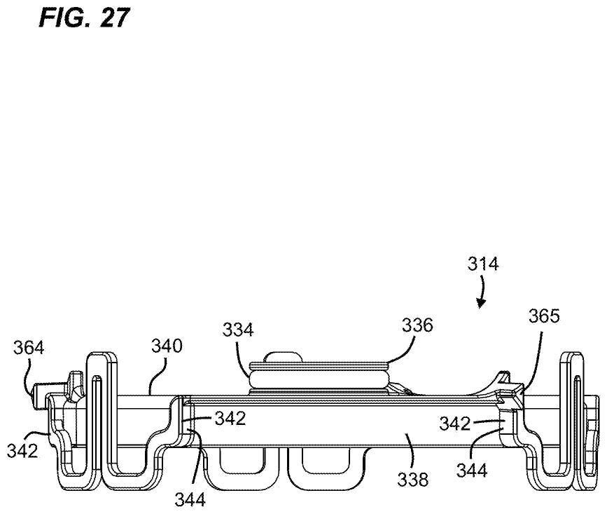

Referring now to FIG. 27, the first end construction 314 includes an outer radial wall 338 and an axial wall 340. The axial wall 340 covers the first end of the media 328. A plurality of ribs 342 project radially from the outer radial wall 338 of the first end construction 314. Each of the ribs 342 has a side 344 positioned and sized to engage the filter bowl 302, when the cartridge 303 is inserted into the bowl 302.

The mouth 316 of the bowl 302 is defined by an end rim 346. As can be seen in FIG. 24, the mouth 316 has a plurality of recessed sections 348, 350, 352. When the filter cartridge 303 is operatively positioned within the bowl 302, the sides 344 of the ribs 342 engage against the rim 346, within the recessed sections 348-352 of the bowl 302.

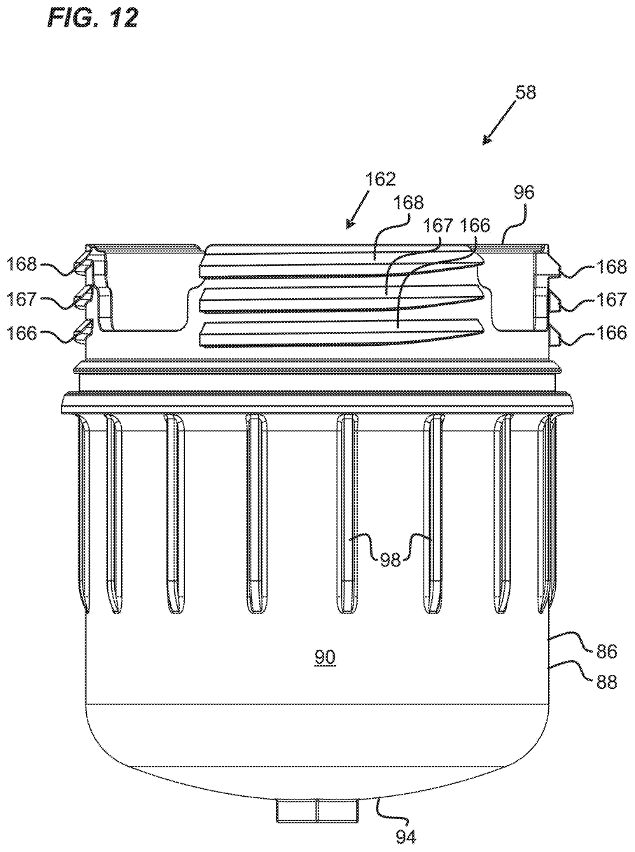

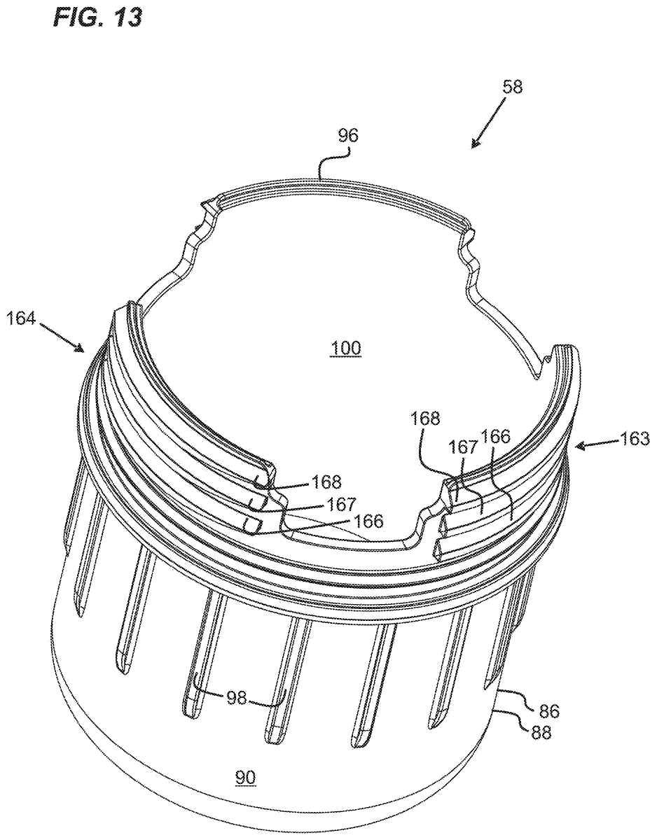

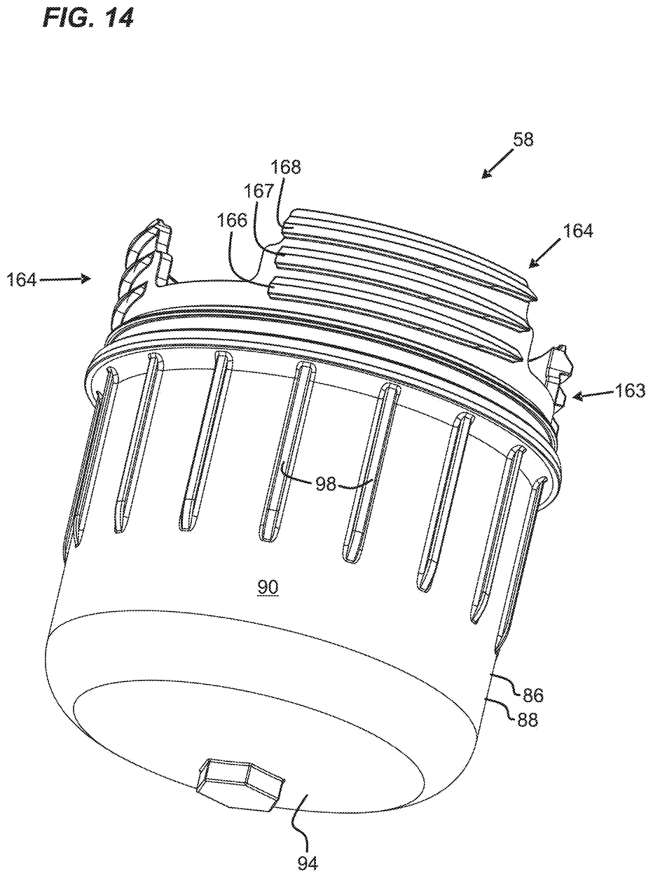

The filter assembly 300 includes the same connection system 160 as described above in connection with assembly 50 and shown in FIGS. 9-18. The connection system 160 includes a plurality of circumferentially spaced connecting sections 162, 163, 164 located on the bowl 302, each including a plurality of parallel section ridges 166, 167, 168 extending circumferentially along and projecting from the outer radial wall 308 of the bowl 302. The outer radial wall 308 has a plurality of alternating circumferentially spaced connecting sections 354, 355, 356 (analogous to the connecting sections 162, 163, 164) and alternating non-connecting sections 170, 171, 172. The recessed sections 348, 350, 352 form the non-connecting sections 170, 171, 172.

In accordance with principles of this disclosure, the filter assembly 300 includes a blocking piece configuration to ensure proper engagement between the filter cartridge 303 and filter head 52. Attention is directed to FIGS. 25 and 26. In this embodiment, the first end construction 314 includes a plurality of blocking pieces 363, 364, 365. The blocking pieces 363, 364, 365 extend radially outwardly from the first end construction 314 and are circumferentially spaced adjacent to at least one of the ribs 342.

The blocking pieces 363-365 can have various configurations, such as a triangular shape, to ensure that the filter cartridge 303 can only be installed in the proper orientation. When the filter cartridge 303 is positioned within the bowl 302, the blocking pieces 363-365 are just above the rim 346 of the bowl 302 and immediately adjacent to the recessed sections 348-352. The blocking pieces 363-365 are also circumferentially adjacent to an end of one of the connecting sections 354, 355, 356.

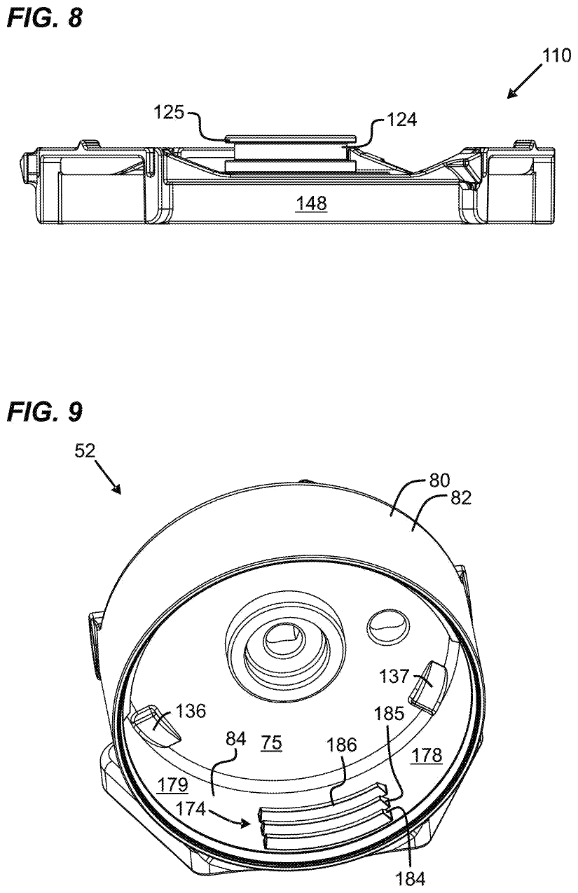

The blocking pieces 363-365 function in the same manner as blocking piece 182 described above. Each blocking piece 363-365 has a length that is larger than the spacing between each segment 184, 185, 186 in the sets 174-176 of segments on the filter head 52 (FIG. 9). Within each set 174-176 of segments on the filter head 52, each connecting segment 184-186 is axially spaced close enough to the adjacent connecting segment 184-186 to block receipt of the blocking pieces 363-365 therebetween. This ensures that the section ridges 166, 167, 168 on the connecting sections 354-358 are properly aligned with the segments 184-186 on the filter head 52. The blocking pieces 363-365 function the same as the embodiment of FIGS. 3-8, ensuring proper alignment and preventing cross-threading or improper connection between the filter assembly 300 and the filter head 52.

The above represents example principles. Many embodiments can be made using these principles.

What is claimed is:

1. A filter cartridge comprising:
(a) a treatment media construction;
(b) a connection system secured to the treatment media construction to allow for removable attachment of the filter cartridge to a receiving member;
(i) the connection system having a blocking piece to ensure proper engagement between the filter cartridge and the receiving member.

2. The filter cartridge of claim 1 wherein:
(a) the treatment media construction has a first end and an opposite second end;
(b) a first end construction is adjacent to the first end of the media construction; and
(c) the blocking piece extends radially outwardly from the first end construction.

3. The filter cartridge of claim 2 wherein:
(a) the blocking piece extends axially from the first end construction and in a direction away from the treatment media construction.

4. The filter cartridge of claim 2, wherein:
(a) the first end construction includes an outer radial wall and an axial wall; the axial wall covering the first end of the media construction;
(b) a plurality of ribs projecting radially from the outer radial wall of the first end construction; each of the ribs having a terminal end sized to engage a rim of a filter bowl, when the cartridge is inserted into a filter bowl; and
(c) the blocking piece being circumferentially spaced adjacent to one of the ribs.

5. A filter assembly comprising:
(a) a filter cartridge including a treatment media construction; and a connection system secured to the treatment media construction to allow for removable attachment of the filter cartridge to a receiving member; the connection system having a blocking piece to ensure proper engagement between the filter cartridge and the receiving member; and
(b) a bowl having an outer radial wall and an interior volume; the filter cartridge being removably mountable within the interior volume; the outer radial wall having a plurality of connecting sections alternating with non-connecting sections; and
wherein, when the filter cartridge is positioned within the bowl, the blocking piece is circumferentially adjacent to an end of one of the connecting sections.

6. The filter assembly of claim 5, wherein:
(a) the bowl has an open mouth in communication with the interior volume; the open mouth being defined by an end rim;
(b) the mouth having a plurality of recessed sections; the recessed sections being the non-connecting sections of the bowl.

7. The filter assembly of claim 6, further comprising:
(a) a filter head removably attached to the bowl with the filter cartridge;
(b) the filter head having an inner radial surface including a plurality of circumferentially spaced sets of connecting segments constructed and arranged to mate with the connecting sections of the bowl; each connecting segment within each set being axially spaced from an adjacent connecting segment;
wherein within each set, each connecting segment is axially spaced close enough to the adjacent connecting segment to block receipt of the blocking piece therebetween.

8. A connection system for releasably connecting first and second components; the system comprising:
(a) a first component having an outer cylindrical wall and a plurality of circumferentially spaced sets of connecting sections; each section having parallel section ridges;
(i) each section ridge having a plurality of regions; each region having a lead different from any other region;
(b) a second component having an inner cylindrical wall and a plurality of circumferentially spaced sets of connecting segments; each set having parallel connecting segments constructed and arranged to mate with the section ridges.

9. The connection system of claim 8, wherein:
(a) each section ridge having first and second opposite ends; and
(b) each section ridge has a first region extending from the first end at least partially toward the second end; the first region having a greater lead than any other portion of the section ridge.

10. The connection system of claim 9, wherein:
(a) each section ridge has a third region extending from the second end;
(b) each section ridge has a second region extending between the first region and third region; and
(c) the lead of the third region is smaller than the lead of the first region or second region.

11. The connection system of claim 10, wherein the lead of the second region is transitional.

12. The connection system of claim 9, wherein:
(a) each section ridge having first and second opposite ends; and
(i) a distance L between corresponding points on adjacent parallel section ridges being non-constant along at least a portion of each section ridge;
(b) the distance L of each section ridge being greatest at the first end.

13. The connection system of claim 9, wherein:
(a) there are at least two sets of connecting sections; and
(b) there are at least two sets of connecting segments.

14. The connection system of claim 9, wherein:
(a) there are at least three sets of connecting sections; and
(b) there are at least three sets of connecting segments.

15. The connection system of claim 9, wherein:
(a) there are at least two parallel section ridges; and
(b) there are at least two parallel connecting segments.

16. The connection system of claim 9, wherein:
(a) there are at least three parallel section ridges; and
(b) there are at least three parallel connecting segments.

17. The connection system of claim 9, wherein:
(a) the first component is a filter assembly; and
(b) the second component is a filter head.

18. The connection system of claim 17, wherein:
(a) the filter assembly comprises a filter bowl having a removable filter cartridge; the filter bowl having the outer cylindrical wall and an open mouth;
(i) the open mouth being defined by an end rim;
(ii) the end rim defining recessed sections; and
(b) the connecting sections on the outer cylindrical wall alternating with the recessed sections.
